(19) United States
(12) Patent Application Publication
(10) Pub. No.: US 2017/0149032 A1
(43) Pub. Date: May 25, 2017

(54) BATTERY PACK

(71) Applicant: Samsung SDI Co., Ltd., Yongin-si (KR)

(72) Inventor: Sora Lee, Yongin-si (KR)

(21) Appl. No.: 15/351,381

(22) Filed: Nov. 14, 2016

(30) Foreign Application Priority Data
Nov. 19, 2015 (KR) 10-2015-0162838

(51) Int. Cl. H01M 2/10; H01M 10/42; H01M 2/20

(52) U.S. Cl. CPC H01M 2/105; H01M 2/204; H01M 10/425; H01M 2220/30

(57) ABSTRACT

A battery pack includes battery cells; a connection tab connected to the battery cells; and a holder being contoured to correspond to the battery cells, the holder comprising an inner surface, an outer surface on which the connection tab is located, and a recess located to correspond to the connection tab.

### CROSS-REFERENCE TO RELATED APPLICATION

This application claims priority to and the benefit of Korean Patent Application No. 10-2015-0162838, filed on Nov. 19, 2015, in the Korean Intellectual Property Office, the entire disclosure of which is incorporated herein by reference.

### BACKGROUND

1. Field

One or more embodiments relate to a battery pack.

2. Description of the Related Art

Unlike primary batteries, secondary batteries are rechargeable. Secondary batteries are used as energy sources of devices such as mobile devices, electric vehicles, hybrid electric vehicles, electric bicycles, and uninterruptible power supplies. Single-cell secondary batteries or multi-cell secondary batteries (secondary battery packs) in which a plurality of battery cells are electrically connected are used according to the types of external devices using the secondary batteries.

Small mobile devices such as cellular phones may be operated by using single-cell secondary batteries. However, multi-cell secondary batteries (secondary battery packs) having high-output, high-capacity features may be suitable for devices having long operating times and consuming large amounts of power such as electric vehicles and hybrid electric vehicles. The output voltages or currents of a battery pack may be increased by adjusting the number of battery cells included in the battery pack.

### SUMMARY

One or more exemplary embodiments include a battery pack in which spaces occupied by connection tabs electrically connecting battery cells to a circuit board are reduced to provide a compact structure.

One or more exemplary embodiments include a battery pack configured to protect connection tabs electrically connecting battery cells to a circuit board.

Additional aspects will be set forth in part in the description which follows and, in part, will be apparent from the description, or may be learned by practice of the presented embodiments.

According to one or more exemplary embodiments, a battery pack includes: battery cells; a connection tab connected to the battery cells; and a holder including an inner surface surrounding the battery cells and/or being contoured to generally correspond to the battery cells, an outer surface on which the connection tab is located, and a recess formed at a position corresponding to the connection tab.

The connection tab may include a bent portion at a position adjacent to a lateral end connecting the inner surface and the outer surface of the holder.

The connection tab may include: a first portion extending toward the outer surface of the holder from a connection member electrically connected to the battery cells; a second portion extending from the first portion and located on the outer surface of the holder; and a bent portion between the first and second portions.

The connection member may electrically connect the battery cells neighboring each other.

The recess may be formed in the outer surface of the holder in a valley between the battery cells neighboring each other.

The recess may be formed in a valley between first and second battery cells neighboring each other, wherein the recess may be centered in the valley and distributed in first and second portions of the holder that cover the first and second battery cells.

A jaw may be formed on the holder in a peripheral region of the recess to support bending of the connection tab.

The connection tab may be inserted between the outer surface of the holder and the jaw.

The jaw may include a protrusion protruding from the holder toward the connection tab.

The recess may be formed in a valley between first and second battery cells neighboring each other, and the jaw may include a pair of protrusions protruding toward the connection tab from first and second portions of the holder covering the first and second battery cells.

The recess may be formed in a valley between first and second battery cells neighboring each other, and the jaw may include a protrusion protruding toward the connection tab from one of first and second portions of the holder covering the first and second battery cells.

The battery pack may further include a circuit board located on the outer surface of the holder, and the connection tab may be connected to the circuit board.

The circuit board and the connection tab may be located on the outer surface of the holder.

A lead may be located between the circuit board and the connection tab for electric connection therebetween.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is an exploded perspective view illustrating a battery pack according to an exemplary embodiment;

FIG. 2 is an exploded perspective view illustrating the battery pack depicted in FIG. 1;

FIG. 3 is a partial perspective view illustrating the battery pack depicted in FIG. 1;

FIGS. 4 and 5 are a perspective view and a plan view illustrating a holder depicted in FIG. 3;

FIG. 6 is a cross-sectional view taken along line VI-VI of FIG. 5;

FIGS. 7 and 8 are views illustrating a connection tab according to a comparative example and a connection tab according to the exemplary embodiment for explaining the influence of spring back;

FIG. 9 is an exploded perspective view illustrating a battery pack according to another exemplary embodiment, the battery pack being provided by modifying the battery pack depicted in FIG. 3;

FIG. 10 is a plan view illustrating a holder depicted in FIG. 10;

FIG. 11 is a cross-sectional view taken along line XI-XI of FIG. 9; and

FIG. 12 is a view illustrating a modification of the battery pack depicted in FIG. 11.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed.

Battery packs will now be described with reference to the accompanying drawings, in which exemplary embodiments are shown.

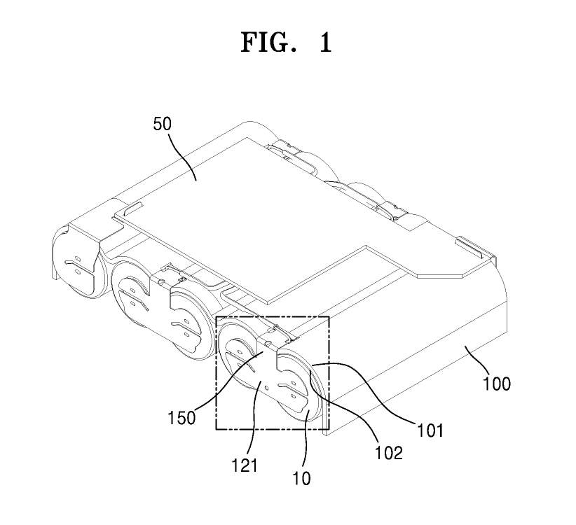

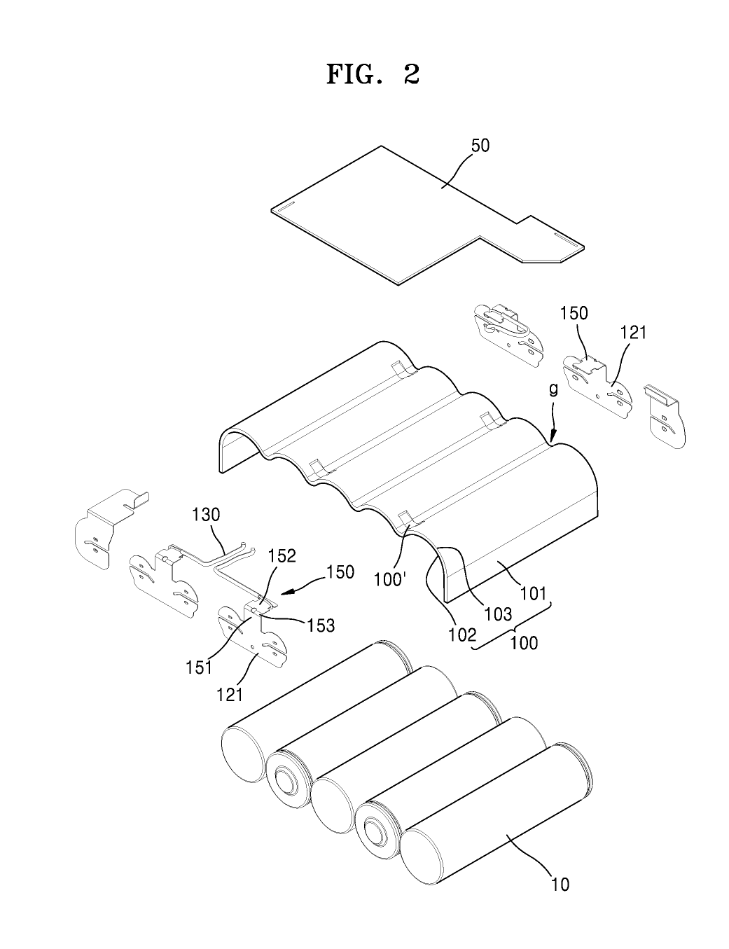

FIG. 1 is an exploded perspective view illustrating a battery pack according to an exemplary embodiment. FIG. 2 is an exploded perspective view illustrating the battery pack depicted in FIG. 1.

Referring to FIGS. 1 and 2, the battery pack may include one or more battery cells 10 and a holder 100 accommodating the battery cells 10.

The battery pack may include a plurality of battery cells 10 electrically connected in series, parallel, or series-parallel. The battery cells 10 may be connected to each other using connection members 121 by a series connection method, a parallel connection method, or a series-parallel connection method. For example, the battery cells 10 may be connected in parallel by connecting electrodes of the battery cells 10 having the same polarity using the connection members 121 or may be connected in series by connecting electrodes of the battery cells 10 having different polarities using the connection members 121.

Each of the battery cells 10 may include different electrodes on both longitudinal ends thereof and may have a cylindrical shape. Valleys (g) may be formed between the battery cells 10 having a cylindrical shape. In the present disclosure, the term “valleys (g)” may refer to concave regions between the battery cells 10 or concave portions of the holder 100 covering the battery cells 10.

At least portions of the holder 100 may have a cylindrical shape to accommodate the battery cells 10 having a cylindrical shape. For example, the holder 100 may accommodate the battery cells 10 and may extend over the valleys (g) between the battery cells 10 to define assembly positions for the battery cells 10.

An inner surface 102 of the holder 100 may surround and/or be generally contoured to correspond to the battery cells 10, and an outer surface 101 of the holder 100 may support a circuit board 50. As described later, the circuit board 50 may be located on the outer surface 101 of the holder 100. In addition, the holder 100 may include lateral ends or edges 103 connecting the inner surface 102 and the outer surface 101. As described later, bent portions 153 of connection tabs 150 may be located adjacent to the lateral ends 103 of the holder 100.

The battery pack may further include the circuit board 50 configured to control charge and discharge operations of the battery cells 10. The circuit board 50 may receive information about certain states of the battery cells 10 and may control charge and discharge operations of the battery cells 10 based on the information. Information about the states of the battery cells 10 may be transmitted to the circuit board 50 through the connection tabs 150 connected to the battery cells 10.

The connection tabs 150 may extend from the connection members 121. For example, the connection tabs 150 may extend from the connection members 121 as part of the connection members 121 and may protrude toward the circuit board 50.

Information about the state of the battery cells 10 connected to the connection members 121 may be transmitted to the circuit board 50 through the connection tabs 150. For example, the connection tabs 150 may electrically connect the battery cells 10 to the circuit board 50 and may transmit information about states of the battery cells 10 to the circuit board 50. The connection tabs 150 may be electrically thermally connected to the battery cells 10 and thus may have the same voltages and temperatures as the battery cells 10. Thus, state information such as voltages and temperatures may be transmitted from the connection tabs 150 to the circuit board 50.

For example, the connection members 121 may connect the battery cells 10 and may transmit information about the voltages of the battery cells 10 to the circuit board 50 through the connection tabs 150. In addition, the connection members 121 may transmit information about the temperatures of the battery cells 10 to the circuit board 50 through the connection tabs 150. For example, the circuit board 50 may receive information about states of the battery cells 10 such as the voltages and temperatures of the battery cells 10 and may control charge and discharge operations of the battery cells 10 based on the information. For example, the circuit board 50 may detect states of the battery cells 10 such as overcharged states, overdischarged states, or overheated states, and may control the battery cells 10, for example, to stop the charge or discharge operations of the battery cells 10.

The connection tabs 150 may be connected to the circuit board 50 through leads 130. The connection tabs 150 and the leads 130 may be connected to each other by soldering. Information about states of the battery cells 10 may be transmitted to the circuit board 50 through the connection tabs 150 and the leads 130. The circuit board 50 and the connection tabs 150 (for example, second portions 152 of the connection tabs 150) may be placed on the outer surface 101 of the holder 100 and may be electrically connected to each other through the leads 130. In other words, the circuit board 50, the connection tabs 150, and the leads 130 located between the circuit board 50 and the connection tabs 150 may be arranged on the outer surface 101 of the holder 100.

The connection tabs 150 may protrude upward from the connection members 121 toward the outer surface 101 of the holder 100 and may be placed on the outer surface 101 of the holder 100. In other words, the connection tabs 150 may protrude upward toward the outer surface 101 of the holder 100 from the connection members 121 connected to the battery cells 10 and may then be bent such that the connection tabs 150 may be placed on the outer surface 101 of the holder 100.

For example, the connection tabs 150 may include: first portions 151 extending toward the outer surface 101 of the holder 100 from the connection members 121 electrically connected to the battery cells 10; second portions 152 extending from the first portions 151 and placed on the outer surface 101 of the holder 100; and bent portions 153 between the first portions 151 and the second portions 152. The bent portions 153 may have a bend angle of at least about 90 degrees so as to securely bring the second portions 152 of the connection tabs 150 into contact with the outer surface 101 of the holder 100 without separation.

The bent portions 153 may be placed adjacent to the lateral ends 103 (i.e., edges) connecting the inner surface 102 and the outer surface 101 of the holder 100. The first portions 151 extending upward from the connection members 121 toward the outer surface 101 of the holder 100 are connected to the second portions 152 placed on the outer surface 101 of the holder 100 through the bent portions 153. In other words, a change of direction occurs at the bent portions 153. Thus, the bent portions 153 may be located close to the lateral ends 103 of the holder 100 adjoining the outer surface 101 of the holder 100.

The connection tabs 150 may be located in the valleys (g) between the battery cells 10. If the connection tabs 150 are located in the valleys (g) between the battery cells 10 as described above, the valleys (g) may be useful in terms of space utilization efficiency, and because the connection tabs 150 do not protrude from the uppermost surface of the holder 100, the battery pack may have a compact structure. The expression “the connection tabs 150 do not protrude from the uppermost surface of the holder 100” may mean that the connection tabs 150 do not protrude from the uppermost surface of the holder 100 such as a surface of the holder 100 covering convex portions of the battery cells 10. In other words, a thickness of the battery pack at the connection tabs may be less than a maximum thickness of the battery pack.

Since the connection tabs 150 are located in the valleys (g) between the battery cells 10, the connection tabs 150 may not physically interfere with other structures and thus may be less damaged if the battery pack is impacted.

Recesses 100′ may be formed in the outer surface 101 of the holder 100 at positions corresponding to the connection tabs 150 to allow for over-bending of the connection tabs 150. The recesses 100′ may include grooves or holes formed in the holder 100 to allow for over-bending of the connection tabs 150. In the exemplary embodiment, the recesses 100′ may include grooves formed in the holder 100 at positions corresponding to the connection tabs 150. In another exemplary embodiment, however, the recesses 100′ may include holes formed in the holder 100 at positions corresponding to the connection tabs 150.

The connection tabs 150 may include a metallic material, and after the connection tabs 150 are bent, the connection tabs 150 may have an elastic bias that forces them to spring back. For example, after the connection tabs 150 are bent, the connection tabs 150 may spring back to their original shapes. Thus, after bending the connection tabs 150, it may be difficult to maintain the bend angle of the connection tabs 150. In other words, the bend angle of the connection tabs 150 may be reduced compared to an angle by which the connection tabs 150 are bent in a bending process. Therefore, the connection tabs 150 may be over-bent by more than about 90 degrees so as to maintain the bend angle of the connection tabs 150 to be at least about 90 degrees.

The recesses 100′ are formed in the outer surface 101 of the holder 100 to allow for over-bending of the connection tabs 150. Owing to the recesses 100′, the connection tabs 150 may be over-bent without being obstructed by the outer surface 101 of the holder 100. In other words, the recesses 100′ allow for over-bending of the connection tabs 150. If the recesses 100′ are omitted from the outer surface 101 of the holder 100, it may be difficult to over-bend the connection tabs 150, and thus after a bending process, the bend angle of the connection tabs 150 may become less than about 90 degrees due to an elastic bias of the connection tab 150. As a result, the connection tabs 150 may be separated from the outer surface 101 of the holder 100. In this case, the connection tabs 150 may physically interfere with other structures or may be easily damaged if the battery pack is impacted. In addition, if the connection tabs 150 are separate and protrude from the outer surface 101 of the holder 100, the volume of the battery pack may increase.

The recesses 100′ may be formed in the outer surface 101 of the holder 100 in the valleys (g) between the battery cells 10. The recesses 100′ may be formed at positions corresponding to the connection tabs 150, and the connection tabs 150 may be located in the valleys (g) between the battery cells 10. In this case, the space of the valleys (g) may be efficiently used, and the connection tabs 150 may not protrude from the outer surface 101 of the holder 100. Furthermore, since the connection tabs 150 are located in the valley (g) between the battery cells 10, the connection tabs 150 may not physically interfere with other structures and may be less damaged if the battery pack is impacted.

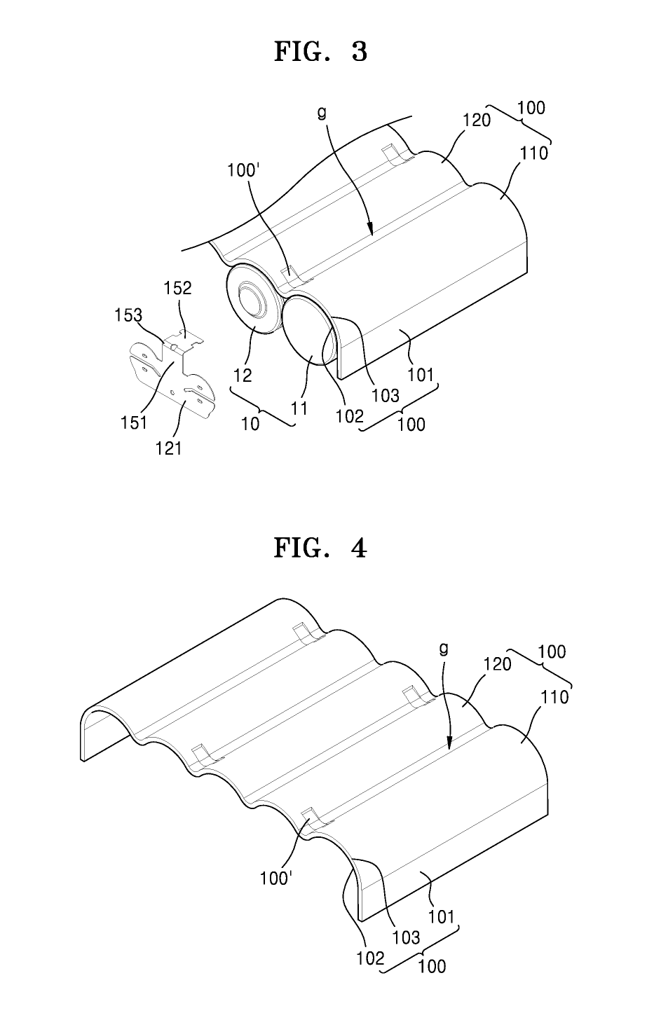

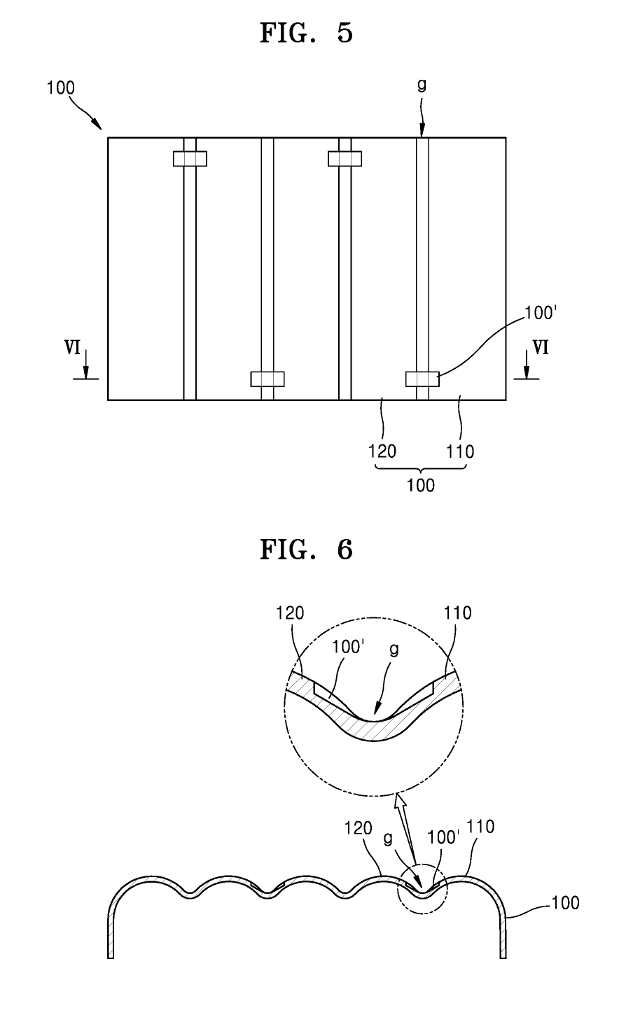

FIG. 3 is a partial perspective view illustrating the battery pack depicted in FIG. 1. FIGS. 4 and 5 are a perspective view and a plan view illustrating the holder 100 depicted in FIG. 3. FIG. 6 is a cross-sectional view taken along line VI-VI of FIG. 5.

Referring to FIGS. 3 to 6, a recess 100′ may be formed in first and second portions 110 and 120 of the holder 100 that cover first and second battery cells 11 and 12 neighboring each other. For example, the recess 100′ may be formed in a valley (g) between the first and second battery cells 11 and 12 (a valley (g) of the holder 100). In this case, the recess 100′ may be distributed in the first and second portions 110 and 120 of the holder 100 that cover the first and second battery cells 11 and 12. The recess 100′ allowing for over-bending of a connection tab 150 may be distributed in the first and second portions 110 and 120 of the holder 100. In other words, the recess 100′ may be divided into regions corresponding to the first and second battery cells 11 and 12 based on the valley (g) between the first and second battery cells 11 and 12 (the valley (g) of the holder 100).

In the exemplary embodiment, the recesses 100′ are formed in the valleys (g) of the holder 100 between the battery cells 10. However, the inventive concept is not limited thereto. For example, in another exemplary embodiment, the recesses 100′ may be formed in convex cylindrical portions of the holder 100. In other words, the recesses 100′ may be formed in any positions of the holder 100 as long as the recesses 100′ are formed at positions corresponding to the connection tabs 150 and allow for over-bending of the connection tabs 150.

The recesses 100′ may be formed at positions corresponding to the connection tabs 150 that are staggered in front and rear regions of the battery pack. For example, the recesses 100′ may be staggered in an alternating pattern at front and rear positions of the holder 100. For example, the connection tabs 150, particularly, the connection members 121, may be alternately arranged at front and rear positions of the battery pack so as to electrically connect the battery cells 10 in series. In this case, the recesses 100′ may be alternately formed at front and rear positions of the holder 100 in accordance with the arrangement of the connection tabs 150.

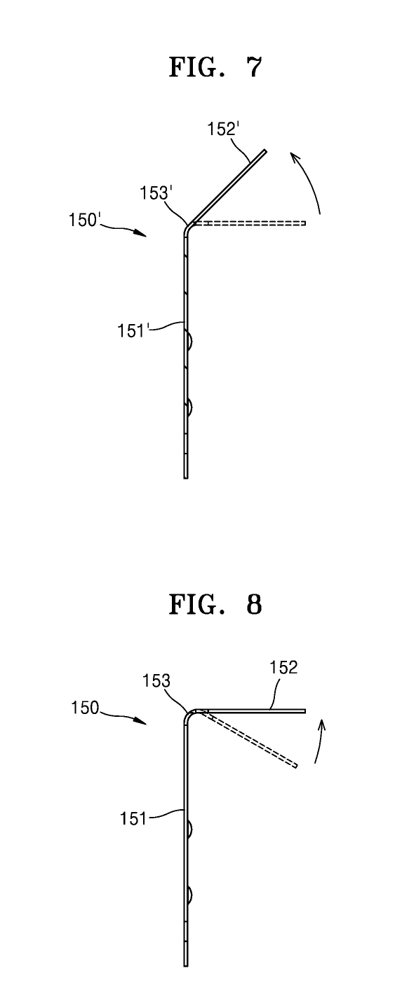

FIGS. 7 and 8 are views for explaining the influence of spring back. FIG. 7 illustrates a connection tab 150′ according to a comparative example, and FIG. 8 illustrates a connection tab 150 according to the exemplary embodiment.

As shown in FIG. 7, if the connection tab 150′ is bent about 90 degrees, the bend angle of the connection tab 150′ becomes less than about 90 degrees because of spring back caused by the elastic bias after the bending. Therefore, the influence of spring back may be considered. In other words, as shown in FIG. 8, if the connection tab 150 is over-bent more than about 90 degrees, the bend angle of the connection tab 150′ may be maintained at about 90 degrees after the bending.

In the exemplary embodiment, the connection tabs 150 are over-bent so that the connection tabs 150 may have a bend angle of about at least 90 degrees after bending, thereby preventing the connection tabs 150 from separating from the outer surface 101 of the holder 100. The recesses 100′ formed in the outer surface 101 of the holder 100 allow for over-bending of the connection tabs 150. In FIG. 7, reference numbers 151′, 152′, and 153′ refer to a first portion, a second portion, and a bent portion of the connection tab 150′ of the comparative example. The bent portion 153′ is located between the first and second portions 151′ and 152′.

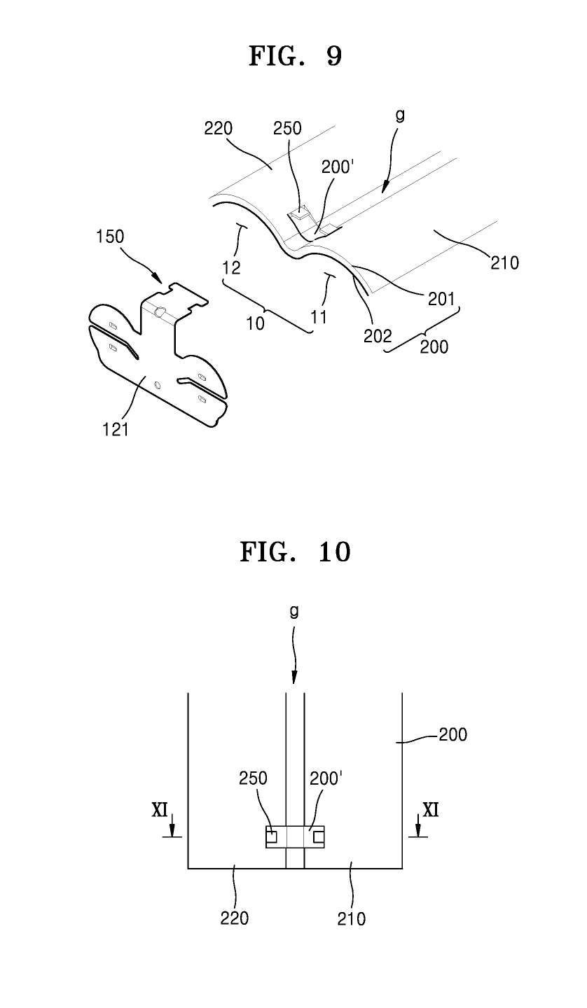

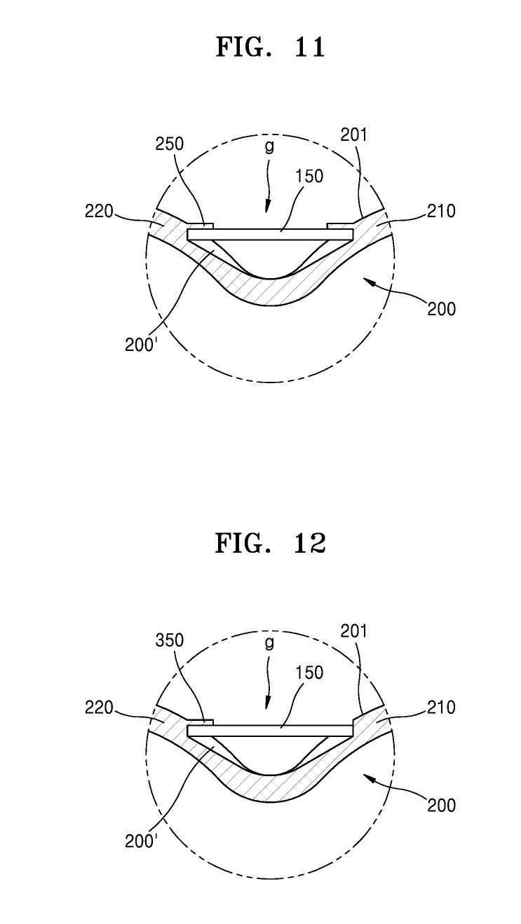

FIG. 9 is an exploded perspective view illustrating a battery pack according to another exemplary embodiment, the battery pack being provided by modifying the battery pack depicted in FIG. 3. FIG. 10 is a plan view illustrating a holder 200 depicted in FIG. 10. FIG. 11 is a cross-sectional view taken along line XI-XI of FIG. 9.

Referring to FIGS. 9 to 11, the battery pack includes battery cells 10 and the holder 200 accommodating the battery cells 10. A recess 200′ is formed in an outer surface 201 of the holder 200 to allow for over-bending of a connection tab 150.

In the exemplary embodiment, jaws 250 may be formed in peripheral regions of the recess 200′ so as to support bending of the connection tab 150. The jaws 250 may support bending of the connection tab 150, and thus the connection tab 150 may be prevented from springing back to maintain its bent state. The connection tab 150 supported by the jaws 250 may be prevented from significantly deforming due to the spring back and may thus maintain a designed bend angle. For example, the connection tab 150 may be inserted between the outer surface 201 of the holder 200 and the jaws 250.

The jaws 250 may be provided in the form of protrusions protruding from the holder 200 toward the connection tab 150. The jaws 250 may have any shape as long as the jaws 250 prevent the connection tab 150 from springing back in a direction opposite to a bending direction of the connection tab 150. For example, the recess 200′ may be formed in a valley (g) between first and second battery cells 11 and 12 neighboring each other in a state in which the recess 200′ is distributed in first and second portions 210 and 220 of the holder 200 covering the first and second battery cells 11 and 12. In this case, the jaws 250 may be formed on the first and second portions 210 and 220 of the holder 200. In other words, the jaws 250 may include a pair of protrusions extending from the first and second portions 210 and 220 toward the connection tab 150.

FIG. 12 is a view illustrating a modification of the battery pack depicted in FIG. 11.

Referring to FIG. 12, a recess 200′ may be formed in an outer surface 201 of a holder 200 to allow for over-bending of a connection tab 150. A jaw 350 may be formed in a peripheral region of the recess 200′ so as to support bending of the connection tab 150.

For example, the recess 200′ may be formed in a valley (g) between first and second battery cells 11 and 12 neighboring each other in a state in which the recess 200′ is distributed in first and second portions 210 and 220 of the holder 200 covering the first and second battery cells 11 and 12. In this case, the jaw 350 may include a protrusion extending from one of the first and second portions 210 and 220 of the holder 200 toward the connection tab 150. For example, the connection tab 150 may be inserted between the outer surface 201 of the holder 200 and the jaw 350.

The jaw 350 may protrude from one of the first and second portions 210 and 220 of the holder 200. For example, as shown in FIG. 11, the jaws 250 protruding from the first and second portions 210 and 220 of the holder 200 in mutually-facing directions (refer to FIG. 11) may stably fix the connection tab 150 and stably maintain a bend of the connection tab 150, and as shown in FIG. 12, the jaw 350 protruding from one of the first and second portions 210 and 220 of the holder 200 may allow the connection tab 150 to be easily inserted against the rigidity of the jaw 350.

As described above, according to the one or more of the above exemplary embodiments, owing to the recesses formed at positions corresponding to the connection tabs, the connection tabs may be easily bent to connect the battery cells to the circuit board and may not be separated from the outer surface of the holder. Therefore, the connection tabs may not be damaged by physical interference with other elements of the battery pack or external structures, and the battery pack may have a compact structure.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A battery pack comprising:
battery cells;
a connection tab connected to the battery cells; and
a holder being contoured to correspond to the battery cells, the holder comprising an inner surface, an outer surface on which the connection tab is located, and a recess located to correspond to the connection tab.

2. The battery pack of claim 1, wherein the connection tab comprises a bent portion located adjacent to an edge of the holder.

3. The battery pack of claim 1, wherein the connection tab comprises:
a connection member electrically connected to the battery cells;
a first portion extending toward the outer surface of the holder from the connection member;
a second portion extending from the first portion and located on the outer surface of the holder; and
a bent portion between the first and second portions.

4. The battery pack of claim 3, wherein the connection member electrically connects adjacent battery cells.

5. The battery pack of claim 1, wherein the recess is formed in the outer surface of the holder in a valley between adjacent battery cells.

6. The battery pack of claim 5, wherein the recess is located in a valley between adjacent first and second battery cells, and
wherein the recess is centered in the valley and located in portions of the holder that cover the first and second battery cells.

7. The battery pack of claim 1, further comprising a jaw on the holder in a peripheral region of the recess to support bending of the connection tab.

8. The battery pack of claim 7, wherein the connection tab is located between the outer surface of the holder and the jaw.

9. The battery pack of claim 7, wherein the jaw comprises a protrusion protruding from the holder towards the connection tab.

10. The battery pack of claim 9, wherein the recess is located in a valley between adjacent first and second battery cells, and
wherein the jaw comprises a pair of protrusions protruding towards the connection tab from respective first and second portions of the holder covering the first and second battery cells.

11. The battery pack of claim 9, wherein the recess is located in a valley between adjacent first and second battery cells, and
wherein the jaw comprises a protrusion protruding toward the connection tab from only one of first and second portions of the holder covering the first and second battery cells.

12. The battery pack of claim 1, further comprising a circuit board located on the outer surface of the holder, and
wherein the connection tab is connected to the circuit board.

13. The battery pack of claim 12, wherein the circuit board and the connection tab are located on the outer surface of the holder.

14. The battery pack of claim 12, wherein a lead is located between the circuit board and the connection tab for electric connection therebetween.
